(19) United States
(12) Patent Application Publication
(10) Pub. No.: US 2010/0055232 A1
(43) Pub. Date: Mar. 4, 2010

(54) DEGRADABLE CHEWING GUM

(75) Inventors: Torbjörn Mathisen, Alvsjo (SE); Bjorn Atthoff, Uppsala (SE)

Correspondence Address: FOLEY AND LARDNER LLP;SUITE 500, 3000 K STREET NW, WASHINGTON, DC, 20007, US

(73) Assignee: IDAR MEDICAL BIODEGRADABLE AB

(21) Appl. No.: 12/515,651

(22) PCT Filed: Nov. 30, 2007
(86) PCT No.: PCT/IB2007/004415

§ 371 Date: May 20, 2009

Related U.S. Application Data
(60) Provisional application No. 60/868,199, filed on Dec. 1, 2006.

(51) Int. Cl. A23G 4/08

(52) U.S. Cl. 426/6

(57) ABSTRACT

The present invention provides a degradable chewing gum base, degradable chewing gum, and methods of making a degradable chewing gum base and degradable chewing gum. The degradable chewing gum base includes at least one polymer or oligomer with at least two ionic groups. The polymers and oligomers possess the chewing characteristics and texture traditionally desired in a chewing gum while simultaneously providing materials which, when exposed to environmental conditions, break down to non-toxic molecules readily assimilated by nature.

### FIELD OF THE INVENTION

The present invention relates to polymer-based degradable chewing gum base, in particular to such gum base comprising at least two ionic groups.

### BACKGROUND OF THE INVENTION

Chewing gum base is traditionally made from various natural latexes like leche, caspi, sorva, nispero, tunu or jelutong but also from natural gums like chicle gum, mastic gum or spruce gum or from synthetic oligomers or polymers such as paraffin wax, polyethylene or polyvinyl acetate. All of the traditional chewing gum base materials used in today's manufacture of chewing gums are inert materials that do not degrade in nature. With the high volumes of chewing gums consumed each year this has become a large environmental concern. To minimize the effects of wrongful disposal of chewing gums in the street, on the pavement and other outdoor public places, U.S. Pat. No. 5,672,367 suggests that the gum base and its additives are made such that the end product is degradable. Therefore, as further suggested in the mentioned patent, a degradable chewing gum base should preferably possess chemical bonds in the backbone structure that will break when the chewing gum is exposed to various climate conditions, such as sun, water and humid atmosphere or temperature changes. A degradable chewing gum base that would disintegrate into finer particles that further can break down into environmental friendly chemical entities would be a solution to this problem. However, thus far this has proven difficult to put into practice.

The abovementioned U.S. Pat. No. 5,672,367 together with US 2004/0180111, US 2004/0156949 and US 2006/0121156 have suggested various synthetic materials for the purpose of manufacturing degradable gum from various aliphatic polyesters. For those skilled in the art, it is well known that aliphatic polyesters are thermoplastic polymers having no or very little resemblance to the elastomeric properties required to formulate a chewing gum. In order to achieve such properties various copolymers or oligomers have been claimed to possess desirable properties characteristic for a chewing gum. The plasticity can be increased by copolymerization, which basically disturbs development of weak forces between polymer chains. Furthermore, the use of polyaxial initiators (US2006/0121156) has the effect of increasing plastic flow at any given temperature, as will the use of low molecular compounds such as cyclic lactones (US2004/0156949), which, in this regard, is to be seen as a plasticizer whose function is to reduce the weak bonds between the polymer chains.

### SUMMARY OF THE INVENTION

It is an object of the present invention to provide a new family of oligomers and polymers specifically designed for use in a degradable chewing gum. Such polymers and oligomers should possess the chewing characteristics and texture traditionally desired in a chewing gum while simultaneously providing materials which, when exposed to environmental conditions, break down to non-toxic molecules readily assimilated by nature.

The degradable gum base of the present invention comprises oligomers or polymers with incorporated ionic groups. Surprisingly, the incorporation of two or more ionic groups result in a degradable oligomer or polymer that can be tailored into a material which possesses degrees of softness and plastic flow properties that are characteristic for a chewing gum.

The invention provides a degradable chewing gum base, or a chewing gum comprising said gum base, where the chewing gum base is made from non water-soluble polymers or oligomers containing labile chemical bonds in the main chain and having at least two ionic groups, having positive or negative charge, capable of interacting with other ionic groups. The chewing gum base may further be combined with charged or neutral water soluble polymers or oligomers being stable or degradable under normal environmental conditions.

The chewing characteristics of the inventive gum base can be altered by the chemical composition of the polymers or oligomers, thus changing the chain stiffness, by varying the charge density in the mixture as well as by addition of various types of additives normally found in chewing gums.

The invention further relates to a product based on the degradable chewing gum base and coated with an outer protective layer having higher modulus than the chewing gum base.

### BRIEF DESCRIPTION OF THE DRAWINGS

FIG. 1 is an illustration of the shear modulus vs. temperature of a first embodiment of the inventive gum base compared to a poly(trimethylene carbonate) polymer.

FIG. 2 is a schematic illustration of the interactions between ionic-terminated oligomers or polymers.

FIG. 3 is an illustration of the shear modulus vs. temperature of a second and third embodiment of the inventive gum base compared to a poly(trimethylene carbonate) polymer.

FIG. 4 is an illustration of the shear modulus vs. frequency at 37 C° of the first, second and third embodiment of the inventive gum base.

FIG. 5 is an illustration of the shear modulus vs. temperature of a fourth embodiment of the inventive gum base compared to the first embodiment.

### DETAILED DESCRIPTION OF THE INVENTION

The present invention discloses the preparation and use of various degradable oligomeric or polymeric ionomers that will interact with each other to form a loose ionic network that possesses such physical and chemical properties which are desirable in a degradable chewing gum.

The disclosed chewing gum has a gum base that is mainly made from degradable polymers or oligomers comprising two or more ionic groups. The disclosed chewing gum has good chewing characteristics, comparable to those of a typical, non-degradable chewing gum. Typically, the polymers or oligomers comprise at least two ionic groups. The ionic charge may be negative or positive and be located anywhere along the polymer or oligomer molecule but is preferably found as charged end-groups. The polymer or oligomer is formed from any suitable monomer. Non-limiting examples of suitable monomers include glycolide, lactide, ethylene carbonate, trimethylene carbonate, P-butyrolactone, 6-valerolactone, ε-caprolactone, dioxanone or dioxepanone or any combinations thereof.

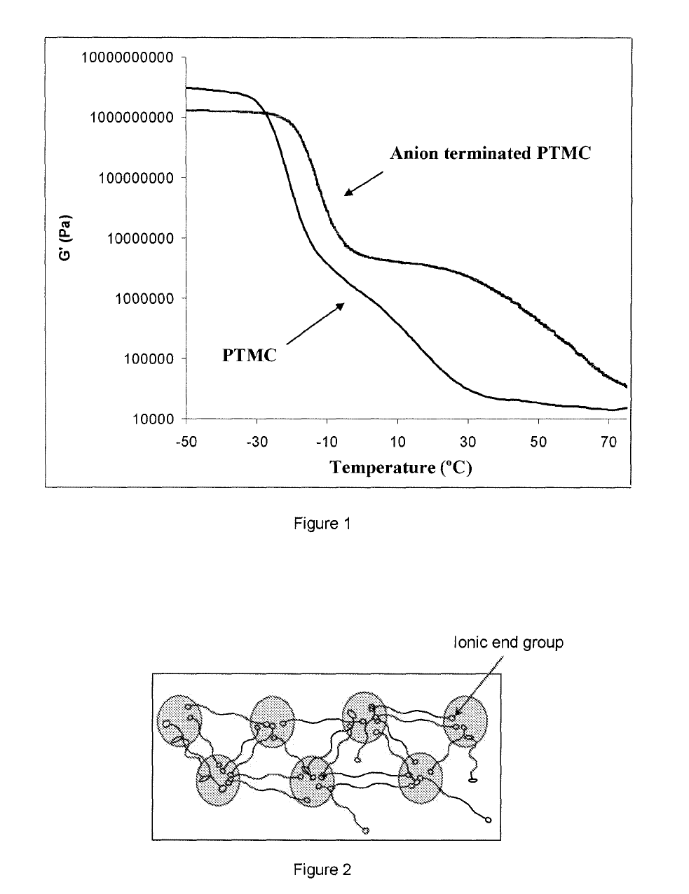

In a first embodiment, the gum base comprises oligomers or polymers comprising negatively charged, anionic end-groups only, to form an anionomer. The extended rubbery plateau of an anionic charged oligomer of trimethylene carbonate can be seen in FIG. 1. As a reference, incorporated in the same figure, is the non-charged oligomer of trimethylene carbonate from which the anionic charged oligomer is made. The rubbery plateau for the anionic oligomer is well extended compared to the non-charged oligomer. This is explained by the formation of ionic clusters within the hydrophobic trimethylene carbonate material as illustrated in FIG. 2. These hydrophilic ionic clusters interact with each other and act as weak physical cross-links in the material, which results in more hindered long range movements of the charged oligomer chains compared to the non-charged oligomer chains, leading to more restricted flow properties. The softening point of the charged and the non-charged oligomer is approximately the same, and also the level of the rubbery plateau immediately after passing through the softening point, indicating that the material softness and the force required to chew the gum base is approximately similar for the charged and the non-charged oligomer. However, when increasing the temperature up to 30° C., which is a typical temperature in the mouth, there is a marked difference between the elastic shear modulus, G′, of the charged ionic oligomer and that of the non-charged oligomer. This difference in shear modulus is contributed by the interactions between the ionic groups leading to a more restricted flow among the molecules.

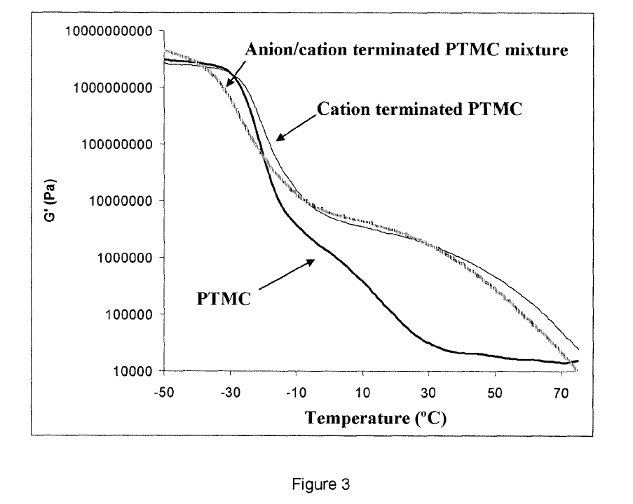

In another embodiment, different oligomers having only positively charged cationic end-groups, cationomers, are blended to obtain similar characteristics as those of oligomers that only possess anionic end groups. The extended rubbery plateau is illustrated in FIG. 3.

To further clarify the invention a set of oligomers having either negative or positive charged end-groups, i.e. anionic or cationic end-groups resulting in anionomers or cationomers, have been prepared from an oligomer of trimethylene carbonate, poly(trimethylene carbonate)-diol, as disclosed in Example 1. The preparation of the anionomer α,ω-di(3-sulfoxy-propoxycarbonyl) poly(trimethylene carbonate) trimethyl ammonium salt is disclosed in Example 6, and the preparation of the anionomer α,ω-di(3-sulfoxy-propoxycarbonyl)poly(trimethylene carbonate) sodium salt is disclosed in Example 7. The preparation of the intermediate compound α-,ω-di(4-chloro butanoyl) poly(trimethylene carbonate) used in preparation of the cationomer is disclosed in Example 8, and the preparation of the cationomer α-,ω-di(N,N,N-trimethyl-4-oxobutane-1-ammonium) poly(trimethylene carbonate) is disclosed in Example 9. The methods or synthetic routes employed in these examples shall by no means be seen as limiting, as those skilled in the art realize that several methods and synthetic routes may be used to produce the same chemical compounds. It should also be noted that although Examples 6, 7, 8 and 9 describe the synthesis of anion and cation terminated oligomer from Example 1, the same synthetic procedures can be employed to convert any of the oligomers from Examples 2 through 5 into anion or cation terminated oligomers.

In yet another embodiment, oligomers having anionic end-groups are combined with oligomers that have cationic end-groups, which further modify the physical properties of the oligomers or polymers. This is most likely caused by a direct ionic interaction between the anionic and cationic end-groups. The effect on the rubbery plateau of the ionic charged oligomers is shown in FIG. 3 for a chewing gum base comprising only cationic oligomers as well as one comprising a combination of cationic and anionic charged oligomers.

In a fourth embodiment, the physical properties of the chewing gum base, comprising at least some oligomers or polymers having anionic end-groups, are modified by addition of alkali earth salts. This is exemplified by, but not limited to, water-soluble magnesium salts or water-soluble calcium salts to provide an even more extended rubbery plateau as well as a higher shear modulus. This embodiment is further described in the text below.

In yet another embodiment the inventive chewing gum base is combined with natural polymers to act as a filling material or to interact ionically with the inventive chewing gum base as described.

In Example 1 the poly(trimethylene carbonate)-diol oligomer is made through ring-opening polymerization which is a convenient and well-known technique for polymerization of various rings containing ester or carbonate functionality. However, it is understood that the oligomers or polymers used in the inventive chewing gum base can be made by any or a combination of polymerization techniques that are well known in the art. The number of end-groups, and thus the maximum charge density for any given oligomer or polymer containing the same amount of monomers consumed during polymerization, can easily be increased by using different initiators. During one common polymerization technique, termed ring-opening polymerization, using various lactones and carbonate rings such as, but not limited to, glycolide, lactide, ε-caprolactone, trimethylene carbonate, dioxanone and dioxepanone, a difunctional initiator is commonly employed. Depending on the ratio between the initiator and the added monomers, either oligomers or polymers having alcohol end-groups will be made. A number of different initiators can be used to produce star-shaped or multi-armed oligomers or polymers having a terminal alcohol group on each arm. Diethylene glycol, trimethylolpropane and pentaerythrodiol are examples of di, tri and tetrafunctional initiators that will produce oligomers or polymers with two, three or four arms, respectively, each having a terminal alcohol group. The diols and polyols mentioned above are only examples and a variety of initiators exist that can be employed to produce multi-armed oligomers and polymers having alcohol end-groups.

Oligomers and polymers can also be made through condensation type polymerization, where molecules having different end-groups are reacted with each other to form oligomers or polymers. The various polymerization techniques for reacting difunctional or bifunctional monomers with each other are well known in the art and may lead to polymers known as polyesters or polyamides. Non-limiting examples of difunctional carboxylic acids and alcohols are malonic acid, succinic acid, glutaric acid, adipic acid, pimelic acid malic acid, fumaric acid, ethylene glycol, diethylene glycol, 1,2-propanediol, 1,3-propanediol, polyethylene glycol, polypropylene glycol, butane diol, and polybutylene glycol.

Yet another well-known polymerization technique is simply to bring two reactive chemical groups together. An example of such reactive groups that upon contact will form a new chemical group is the formation of various polyurethanes. Non-limiting examples are the formation of urethane groups upon the reaction between an alcohol and an isocyanate group, an amine and an isocyanate group or the reaction between two isocyanate groups in the presence of water.

Atom transfer polymerization is yet another polymerization method where initiation often is accomplished by a functional initiator. The oligomers or polymers formed usually have different functional end-groups but the hetero telechelic oligomer or polymer can be α,ω-functionalized through reaction of the halogen end-groups. The so formed difunctional telechelic polymers or oligomers can further be converted into an ionic functional group having desirable properties for the inventive gum base.

Furthermore, systems that can utilize both water and/or sunlight to trigger the degradation can be polymerized by radical polymerization of vinyl monomers such as, but not limited to, ethene, propylene, butadiene, various acrylates and vinylacetate copolymerized with various ketene acetales or carbon monoxide.

One prerequisite for the abovementioned oligomers or polymers to be used in the inventive chewing gum base is that the end formulation or chewing gum possesses a softening point below about 37° C., or more preferably below room temperature, about 25° C. This is most easily achieved by using an oligomer or polymer, a blend comprising a first and second of such oligomers or polymers, or a blend comprising more than two of such oligomers or polymers, which results in a gum base or chewing gum having a softening point of about 37° C. or lower. The second oligomer or polymer has a different chemical structure from the first oligomer or polymer and may be charged or uncharged. The softening point is defined as the glass transition temperature as measured by DSC, or the primary modulus transition temperature known as Tα as measured by dynamic mechanical analysis or on a rheometer and defined by the onset or inflection point in the thermogram. As known to those skilled in the art, the softening point is primarily dependent on the chemical structure and chain length of the oligomer or polymer and can thus easily be manipulated by methods such as copolymerization or mixing the oligomer or polymer with known plasticizers.

A series of polymers and copolymers using ring opening polymerization are disclosed in Examples 1 through 5. These are only an illustration of the variety of different oligomers and polymers that can be employed in the inventive chewing gum base and how one can manipulate the softening point, Tα, in a polymer or oligomer.

TABLE 1

| | | Monomer | | |
|---|---|---|---|---|
| | | ratio | Tα | Plateau range |
| Example | Monomers | weight % | ° C. | ° C. |
| Example 1 | TMC Diol | 100 | −28 | −15 to +5 |
| Example 2 | TMC/PDO 90/10 Diol | 90/10 | −36 | −22 to +20 |
| Example 3 | TMC/PDO 60/40 Diol | 60/40 | −48 | −25 to +5 |
| Example 4 | TMC/DLA Diol | 90/10 | −29 | −12 to +12 |
| Example 5 | TMC/CL/GA Diol | 45/45/10 | −69 | −54 to 0 |

In the examples in Table 1 a limited number of monomers have been used to illustrate that various copolymers can be used to manipulate the softening point of oligomers and polymers used in the inventive chewing gum base. Non-limiting examples of various monomers that can be copolymerized with each other to manipulate various physical properties of the chewing gum base are glycolide, lactide, valerolactone, β-butyrolactone, ε-caprolactone, dioxanone, dioxepanone or any of their substituted counterparts, or substituted or non-substituted cyclic anhydrides or carbonates such as ethylene carbonate or trimethylene carbonate. Blends of one, two, or more homo- and copolymers can furthermore be used to achieve the desired softening point.

The oligomers or polymers can be made with a plurality of molecular weights. Higher molecular weight may dilute the ionic interactions. Thus it is desirable to keep the molecular weight at a certain level, such that both the softening point and the rubbery plateau are held within in a range that will impart good chewing characteristics to the chewing gum. It is understood that different oligomer or polymer combinations may exhibit different molecular weights, and that the type of ionic species and the number of ionic groups contained in each oligomer or polymer may differ, in order to fulfill the requirement on the softening point and the rubbery plateau, depending on which monomer or monomers are used to produce the oligomer or polymer. The molecular weight for the degradable synthetic oligomers or polymers is desirably found below 100,000 g/mol, more preferably below 50,000 g/mol and most preferably in the range of 500 to 20,000 g/mol. When different oligomers or polymers are used in the inventive gum base these may have different molecular weights to obtain the preferred softening point and plastic flow characteristic of the gum base material. The softening point should preferably be below about 37° C., and more preferably below about 25° C. The flow characteristics are best characterized by the use of a rheometer. It must be observed that the values read from such an instrument can vary depending on conditions used; however a preferable range for the elastic shear modulus at a temperature around 30° C. would be about 1 kPa to 50 MPa, or more preferably in the range of about 10 kPa to 10 MPa, measured at a deformation frequency of 10 Hz. If water-soluble polyionic species are used in the inventive gum base material, the molecular weight can be considerably higher than stated above due to the hydrophilic nature and high charge density often found in such oligomers or polymers. Especially for natural polymers such as proteins or carbohydrates, the molecular weight is not recognized as a limiting factor with respect to good chewing characteristics.

Furthermore, softening point reduction and changes in flow characteristics can be obtained by adding plasticizer to the oligomer or polymer as is well known in the art. Examples of plasticizers that can be used are different citric acid esters such as triethyl-, propyl-, butyl-, pentyl- and hexylcitrate as well as acetyl triethyl-, acetyltributyl-, acetyltripropy-, acetyltributyl-, acetyltripentyl- and acetyl trihexylcitrate. Furthermore tricaetin, various mono- and disaccharides as well as water can be used as plasticizers. The examples above are non-limiting examples of low molecular weight molecules that can be used as plasticizers for numerous aliphatic polymers, since several low molecular weight compounds can be used to bring down the glass transition temperature of an oligomer or polymer.

As disclosed above, the chemical structure and the molecular weight of the oligomer or polymer, as well as additives such as plasticizers, will all affect the softening point of the chewing gum base. The optimum softening point will be different for different oligomers, polymers or mixtures of the same, and no general interval can be defined, except that the softening point should be below body temperature, i.e. less than about 37° C. The softening point characterizes the temperature where the oligomer or polymer will be free to move upon deformation and is thus an important characteristic of any chewing gum base or chewing gum. However, a chewing gum base also needs to possess a property that counteracts its ability to flow, or more correctly the degree of plastic deformation, which will increase at temperatures above the softening point. The ionic end-groups of the inventive chewing gum base most effectively hinder extensive plastic deformation at temperatures higher than the softening point for any oligomer or polymer. This effect can be seen in FIG. 1 for the anion produced according to Examples 1 and 7, for the cation produced according to Examples 1 and 9, and for the mixture of anion and cation produced according to Example 10.

In FIG. 1, the softening point, Tα, for the hydroxyl terminated polytrimethylene carbonate oligomer is found at −28° C., while the rubbery plateau is only vaguely expressed in the range −15 to +5° C., i.e. the oligomer behaves like a highly viscous liquid. However, when the same oligomer is terminated by anionic sulphate groups, the softening point moves to a slightly higher temperature, while the rubbery plateau is much more pronounced and expressed in the range −10 to +30° C., which means that the ability to flow is greatly hindered by the interactions developed among the ionic end-groups. The same effect is shown for the cationic terminated oligomer in FIG. 3. It is however not clear that mixing of the anionic and cationic terminated oligomers as done in Example 10 has any extra effect on the rubbery plateau when a simple temperature scan is performed in the rheometer.

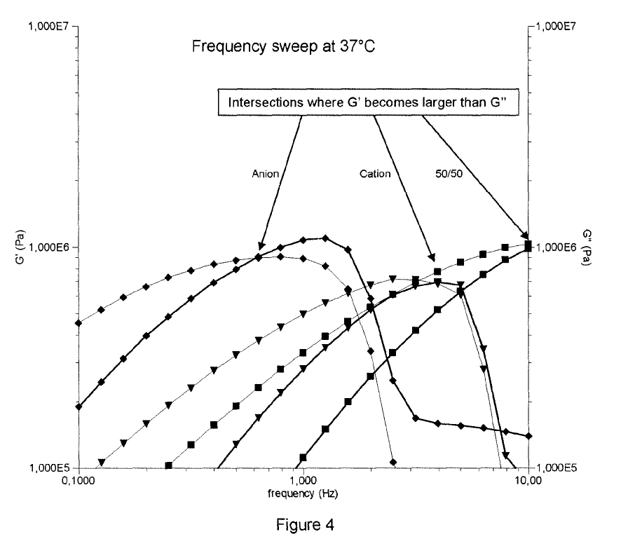

In FIG. 4 is shown a frequency scan performed in the rheometer at constant temperature of 25° C., and a marked difference between the mixture and the anion or cation terminated oligomers can be seen. At low deformation rates the loss modulus (a measure of flow and plastic deformation) is higher than the storage modulus (a measure of the elastic energy stored in the material) which means that the material easily flows and behaves more like a viscous liquid. It is seen in FIG. 4 that higher deformation rates are needed for the elastic modulus of the mixture to become higher than the loss modulus, which means that the softening point also will be pushed towards lower temperatures for the mixture compared to the pure anion or cation terminated oligomer as can be seen in FIG. 3 for the cation and FIG. 1 for the anion. It is therefore obvious from the above that the anion and cation terminated oligomers and polymers will extend the rubbery plateau and that the mixture of the two can be used to further modify the rheological properties of the chewing gum base to yield good chewing characteristics. It is also understood that for any given oligomer or polymer system consisting of anion or cation terminated end-groups, with or without pendant ionic groups, or any combinations of these, good chewing characteristics can be achieved by a plurality of different formulations. Furthermore, the examples disclosed in this document by no means shall be limiting in terms of oligomers, ionic species or any other additive used to achieve the inventive chewing gum base. The extended rubbery plateau for some anion and cation terminated oligomers is illustrated in Table 2.

TABLE 2

| | | Molar | | |
|---|---|---|---|---|
| | | ratio | Tα | Plateau range |
| Example | Monomers | weight % | ° C. | ° C. |
| Example 01 | TMC diol terminated | 100 | −28 | −15 to +5 |
| * | TMC anion terminated | 100 | −18 | −7 to +35 |
| ** | TMC cation terminated | 100 | −26 | −7 to +40 |
| *** | TMC mixture of anion and cation | 100 | −33 | −13 to +32 |
| Example 2 | TMC/PDO 90/10 diol terminated | 90/10 | −36 | −22 to +20 |
| * | TMC/PDO 90/10 anion terminated | 90/10 | −34 | −11 to +37 |
| ** | TMC/PDO 90/10 cation terminated | 90/10 | −28 | −12 to +32 |
| *** | TMC/PDO 90/10 mixture of anion and cation | 90/10 | −31 | −6 to +32 |
| Example 3 | TMC/PDO 60/40 diol terminated | 60/40 | −48 | −25 to +5 |
| * | TMC/PDO 60/40 anion terminated | 60/40 | −46 | −7 to +26 |
| ** | TMC/PDO 60/40 cation terminated | 60/40 | −39 | −12 to +17 |
| *** | TMC/PDO 60/40 mixture of anion and cation | 60/40 | −30 | −11 to +22 |
| Example 4 | TMC/DLA diol terminated | 90/10 | −29 | −12 to +12 |
| * | TMC/DLA anion terminated | 90/10 | −29 | −3 to +28 |
| ** | TMC/DLA cation terminated | 90/10 | −24 | −2 to +32 |
| *** | TMC/DLA mixture of anion and cation | 90/10 | −18 | 0 to +33 |
| Example 5 | TMC/CL/GA diol terminated | 45/45/10 | −69 | −54 to 0 |
| * | TMC/CL/GA anion terminated | 45/45/10 | −57 | −30 to +30 |
| ** | TMC/CL/GA cation terminated | 45/45/10 | −60 | −29 to +15 |
| *** | TMC/CL/GA mixture of anion and cation | 45/45/10 | −57 | −40 to +13 |

* Made according to Example 6 and 7.
** Made according to Example 8 and 9.
*** Made according to Example 10.

From Table 2 one can see that the range of the rubbery plateau has been positioned towards higher temperatures for both the anion and cation terminated oligomers. It is also worth noting that for some of the oligomers the rubbery plateau has been extended over a broader temperature range.

Although the disclosed examples uses the ionic groups quaternary amine and sulphate to illustrate the change in physical properties for different oligomers, it is appreciated by those skilled in the art that several ionic species can be used either as end-groups or pendant or side groups to obtain similar effects, and therefore also can be used to manufacture the inventive degradable chewing gum base or chewing gum. Without limitation the ionic end-groups that preferably can be used are various forms of ammonium, amine, sulfate, sulphone, phosphate, phosphorylcholine and carboxylic ions. The ionic end-groups of the first oligomer or polymer are chosen with respect to the counter-ion used on the second oligomer or polymer employed in manufacturing the inventive chewing gum base, such that the two species possess opposite charges. However, as described above, oligomers having only anionic or cationic end-groups can also be employed, as well as oligomers or polymers with pendant ionic groups.

In a further embodiment, oligomers or polymers may also have different charges on their end-groups, so called zwitterionic species, which also leads to an extended rubbery plateau.

The art of converting a functional group into another functional group is well known within the discipline of organic chemistry and to those skilled in the art. In a further embodiment, oligomers or polymers may comprise different chemical functional groups. The chemical functional group may be an ester, a carbonate, an anhydride, a urethane, or any other chemical functional group known in the art. A most convenient way of converting polymers or oligomers having terminal hydroxyl groups into ionic species such as sulfate and quaternary ammonium, is in detail explained by Examples 6, 7, 8 and 9 below. It is obvious to those skilled in the art that other functional end-groups or adjacent groups can be converted into a variety of ionic species that will impart such desirable properties as those described above and therefore may be used in the formulation of a degradable chewing gum base. Only to illustrate what is generally known in the art, the phosphate anion can be made by use of POCl₃ and the sulphate anion can be made with the use of sulfamic acid. The later is probably a more economic route than the use of any type of SO₃ complex as disclosed here.

The oligomers or polymers having ionic end-groups may also interact or coordinate with or bind to a second, third, or additional material. Non-limiting examples of such materials are non-organic materials, synthetic polymers, natural polymers, synthetic copolymers, natural copolymers, synthetic polymers having a plurality of charged groups, natural polymers having a plurality of charged groups, synthetic copolymers having a plurality of charged groups, natural copolymers having a plurality of charged groups, or proteins. Non-limiting examples of such non-organic materials are various forms of ionic alkali earth metals such as magnesium or calcium ions, but also other metal-based compounds such as calcium carbonate, calcium sulfate, calcium phosphate, calcium magnesium carbonate, calcium fluoride, titanium dioxide and similar compounds. Such compounds have ionic charges on their surface capable of interacting with the ionic oligomers. This interaction can further be enhanced by small changes in the pH of the surrounding media.

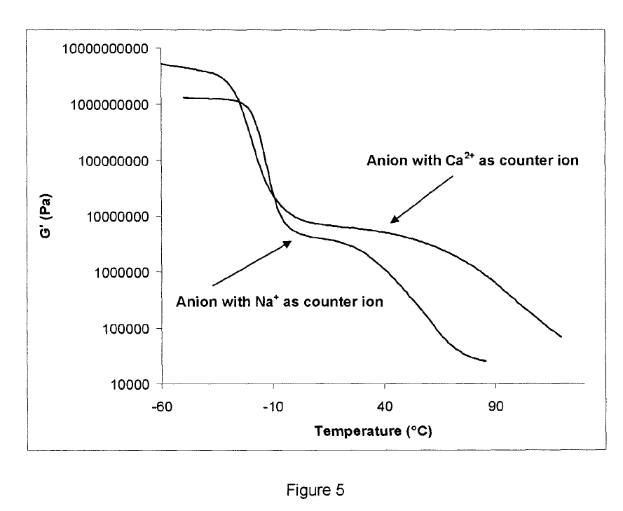

An example of an approach to deliver free calcium ions, or highly dissociated calcium ions, to the gum base material, would be to incorporate calcium chloride as exemplified in Example 11. Strong interaction between the calcium ions and the trimethylene carbonate oligomer having sulphate end-groups can be seen in FIG. 5, where the rubbery plateau of the mixture between calcium ions and the sulphate terminated oligomer of trimethylene carbonate is showed together with the sulphate terminated oligomer of trimethylene carbonate only. The rubbery plateau of the mixture is greatly extended compared to the anion terminated oligomer alone. This feature is accomplished by the relative strong ionic bond being developed between the calcium ion and terminal sulphate group on the trimethylene carbonate oligomer used in this example. However, the effect is the same if other sulphate terminated oligomers or polymers as described earlier are used. It is also noted in FIG. 5 that ions which bind strongly to sulphate, or any other anionic end-group that may be used, will increase the storage modulus in the rubbery plateau zone. This is a recognized and valuable feature for manipulation of the chewing characteristics of the inventive chewing gum base or chewing gum.

The same effect as shown above is achieved with, but not limited to, phosphate and carboxyl groups. Such addition of any type of non-toxic inorganic species to the chewing gum base will lead to a change in the plastic flow behavior and thus the chewing characteristics of the chewing gum. Furthermore, incorporation of a second or additional material as a synthetic water-soluble polymer, a natural water-soluble polymer, a synthetic water-soluble oligomer, a natural water-soluble oligomer, a peptide, a disaccharide, an oligosaccharide, or a polysaccharide. Typically, the synthetic or natural polymers comprise a plurality of charged groups, such as, but not limited to, various glucosaminoglycans, pectins, alginates, hyalauronic acid, chitosan and other charged carbohydrates as well as proteins such as, but not limited to, zein or soy protein or synthetic charged polymers such as polyacrylic acid, may increase the charge density in the gum base and further change the plastic flow characteristics.

To illustrate the degradation of the inventive chewing gum base, equal portion of cation and anion terminated oligomers from Example 2, 3, 4 and 5 were mixed according to Example 10. The mixtures was aged at 50° C. in a phosphate buffer solution with pH 7.2 and in an outdoor environment during the months July, August and September in Uppsala, Sweden, where the weather shifts from sunny days to rain and the temperature usually stays in the range of 18 to 27° C. After 3 months in the outdoor environment the gum base made, according to Example 10, from a mixture of cationic and anionic oligomers described in Example 3 and 5, was severely degraded and roughly 80% of the mass was gone. Similar observations were made for those samples stored at 50° C. Those mixtures made from oligomers as described in Examples 2 and 4 were as expected more resistant to degradation, and not until after 5 months the degradation had proceeded so far that the samples easily fragmented. The limited degradation test described above is merely included to show that the polymers or oligomers in the inventive chewing gum base do degrade, allowing the chewing gum base and the chewing gum to degrade and disintegrate.

In a further embodiment, the inventive chewing gum base can be made to manufacture chewing gums aimed for administration of a stimulant or pharmaceutical ingredient. Non-limiting examples of additives include nicotine as a mean to quit smoking, various ingredients to enhance oral health such as fluoride containing salts to prevent caries, chlorhexidine, minocycline, doxycycline or other tetracycline antibiotics for alleviation of gingivitis and possibly periodontitis and furthermore miconazole for treatment of fungal infections in the mouth. On the cosmetic side, various whitening agents can be added to improve the whitening of the teeth. The examples given above are by no means limiting and several pharmaceutical active ingredients can be administered by use of the inventive chewing gum base. Guarana to treat obesity, pain killers such as aspirin and several other active ingredient candidates indicated to treat or alleviate symptoms caused by allergy, nausea, motion sickness, diabetes, anxiety, dyspepsia, osteoporosis and cough or cold are only a few examples. One particular advantage of the inventive chewing gum base in this respect is the fact that it is made up of both hydrophilic and hydrophobic domains, which allow incorporation of both hydrophilic and/or hydrophobic pharmaceutical ingredients. Another advantage of the inventive chewing gum base is that it can be composed of one or more active chemical groups that can interact with the drug, weak or strong, so that a specific release profile can be calculated.

Although the present invention has been described with reference to specific embodiments it will be apparent to those skilled in the art that many variations and modifications can be envisioned within the scope of the invention as described in the specification and defined with reference to the claims below.

The invention is further described in the following non-restrictive examples.

### EXAMPLES

### Example 1

### Synthesis of poly(trimethylene carbonate)-diol, 4000 g/mol

A 1000 mL two-necked Schlenk flask equipped with a stir bar was carefully flame-dried under vacuum and purged with nitrogen before 500 g (4.9 mol) trimethylene carbonate, 2.45 g (6.13 mmol) Sn(Oct)₂ and 11 g (0.123 mol) 1,4 butanediol were added inside the glove box for a DP of 40 (20/arm). The closed reaction mixture was stirred at 110° C. for 4 h in an oil bath. ¹H-NMR (CDCl₃)=1.73 (m, 2H, —CH₂—, initiator), 1.86 (m, 2H, —CH₂—CH₂—OH, end group,), 2.05 (m, 2H, —CH₂—, poly), 3.73 (t, 2H, —CH₂—OH, end group), 4.22 (t, 4H, —CH₂—, poly).

### Example 2

### Synthesis of poly(trimethylene carbonate-co-p-dioxanone)-diol 90:10, 4000 g/mol

A 500 mL two-necked Schlenk flask equipped with a stir bar was carefully flame-dried under vacuum and purged with nitrogen before 90 g (0.88 mol) trimethylene carbonate, 10 g (0.1 mol) para-dioxanone, 0.49 g (1.2 mmol) Sn(Oct)₂ and 2.21 g (0.025 mol) 1,4-butanediol were added inside the glove box for a DP of 40 (20/arm). The closed reaction mixture was stirred at 110° C. for 4 h in an oil bath.

### Example 3

### Synthesis of poly(trimethylene carbonate-co-para-dioxanone)-diol 60:40, 4000 g/mol

A 500 mL two-necked Schlenk flask equipped with a stir bar was carefully flame-dried under vacuum and purged with nitrogen before 60 g (0.59 mol) trimethylene carbonate, 40 g (0.39 mol) para-dioxanone, 0.49 g (1.2 mmol) Sn(Oct)₂ and 2.21 g (0.025 mol) 1,4-butanediol were added inside the glove box for a DP of 40 (20/arm). The closed reaction mixture was stirred at 110° C. for 4 h in an oil bath.

### Example 4

### Synthesis of poly(trimethylene carbonate-co-DL-lactide)-diol 90:10, 4000 g/mol

A 500 mL two-necked Schlenk flask equipped with a stir bar was carefully flame-dried under vacuum and purged with nitrogen before 90 g (0.88 mol) trimethylene carbonate, 14 g (0.10 mol) DL-lactide, 0.49 g (1.2 mmol) Sn(Oct)₂ and 2.21 g (0.025 mol) 1,4 butanediol were added inside the glove box for a DP of 40 (20/arm). The closed reaction mixture was stirred at 110° C. for 4 h in an oil bath.

### Example 5

### Synthesis of poly(trimethylene carbonate-co-ε-caprolactone-co-glycolide)-diol 45:45:10, 4000 g/mol

A 500 mL two-necked Schlenk flask equipped with a stir bar was carefully flame-dried under vacuum and purged with nitrogen before 45 g (0.44 mol) trimethylene carbonate, 45 g (0.44 mol) ε-caprolactone, 11.37 g (0.10 mol) glycolide, 0.49 g (1.2 mmol) Sn(Oct)₂ and 2.21 g (0.025 mol) 1,4-butanediol were added inside the glove box for a DP of 40 (20/arm). The closed reaction mixture was stirred at 110° C. for 4 h in an oil bath.

### Example 6

### Synthesis of α,ω-di(3-sulfoxy-propoxycarbonyl)poly(trimethylene carbonate)trimethyl ammonium salt (2) (Anionomer)

A 500 mL round bottom flask equipped with a stir bar was carefully flame-dried under vacuum and purged with nitrogen before 100 g (0.025 mol) of oligomer from Example 1, 10 g (0.072 mol) of sulfur trioxide trimethylamine complex and 300 mL of DMF were added to the flask. The closed reaction mixture was stirred at 60° C. for 16 h in an oil bath. After the reaction was finished the product was filtered. ¹H-NMR (CDCl₃)=1.73 (m, 2H, —CH₂—, initiator), 2.05 (m, 2H, —CH₂—, poly), 2.93 (d, 9H, HN⁺(CH₃)₃, counter ion), 4.22 (t, 4H, —CH₂—, poly).

### Example 7

### Ion exchange of polymer in Example 2 to α,ω-di(3-sulfoxy-propoxycarbonyl)poly(trimethylene carbonate) sodium salt (Anionomer)

The 500 mL round bottom flask equipped with a stir bar and the oligomer from Example 6 was used. To the flask 10 g, (0.12 mol) solid sodium hydrogen carbonate was added. The reaction mixture was stirred at room temperature for 16 h. Following completion of the reaction the solution was precipitated into 2 L of diethyl ether and then washed in an additional 2 L of diethyl ether. The precipitate was dissolved in dichloromethane, filtered and precipitated in 2 L of cold methanol. This was done twice. The precipitate was allowed to sediment and washed repeatedly with methanol and then dried under vacuum at 40° C. until constant weight. ¹H-NMR (CDCl₃)=1.73 (m, 2H, —CH₂—, initiator), 2.05 (m, 2H, —CH₂—, poly), 4.22 (t, 4H, —CH₂—, poly).

### Example 8

### Synthesis of α-,ω-di(4-chloro butanoyl)poly(trimethylene carbonate) (Intermediate Used in the Synthesis of a Cationomer)

A 1000 mL round bottom flask equipped with a stir bar was carefully flame-dried under vacuum and purged with nitrogen before 100 g (0.025 mol) of oligomer from Example 1, 6.36 g (0.06 mol) 4-chlorobutyryl chloride were dissolved in 400 mL of dichloromethane. The closed reaction mixture was stirred at room temperature for 24 h before drying under vacuum at 50° C. for 24 h. ¹H-NMR (CDCl₃)=1.73 (m, 2H, —CH₂—, initiator), 2.05 (m, 2H, —CH₂—, poly), 2.47 (t, R—O₂C—CH₂—, end), 3.55 (t, —CH₂—Cl, end), 4.22 (t, 4H, —CH₂—, poly).

### Example 9

### Synthesis of α-,ω-di(N,N,N-trimethyl-4-oxobutane-1-ammonium) poly(trimethylene carbonate) (Cationomer)

All of the oligomer from Example 8, still in the 1000 mL round bottom flask was dissolved in 400 ml of acetonitrile and cooled to −20° C. Then 1 mL of trimethylamine was added through a needle. The closed reaction mixture was stirred at 60° C. for 24 h before drying under vacuum at 50° C. for 48 h. ¹H-NMR (CDCl₃)=1.73 (m, 2H, —CH₂—, initiator), 2.05 (m, 2H, —CH₂—, poly), 2.51 (t, —CO—CH₂—, end), 3.44 (s, —N⁺(CH₃)₃, end), 3.75 (m, —CH₂—N⁺(CH₃)₃, end), 4.22 (t, 4H, —CH₂—, poly).

### Example 10

### Mixing of Chewing Gum Base A

5 g (1 mmol) of anionomer from Example 7 and 5 g (1 mmol) of the cationomer from Example 9 was kneaded manually for 5 minutes before it was allowed to swell in 100 ml of de-ionized water for 1 h. After swelling the mixture was agitated vigorously for 10 minutes before centrifuged at 5000 rpm for 10 minutes. The water was replaced with 100 ml of fresh de-ionized water and the same procedure was repeated. Then the polymer mixture was dried under vacuum at 40° C. until constant weight.

### Example 11

### Mixing of Calcium Chloride and Sulphate Terminated Oligomer of Trimethylene Carbonate

The sulphate terminated anion ion oligomer or trimethylene carbonate, sodium as counter, was synthesized according to Example 1, 6 and 7. The anionic oligomer, 5.9 g, was dissolved into 50 mL of DMF in a beaker equipped with a magnetic stirring bar. A calcium chloride solution, 3 g CaCl₂.2H₂O in 3 ml H₂O, was added drop wise under constant stirring and further stirred for 15 minutes. The oligomer was precipitated into methanol, separated from the solution and hand kneaded before drying in vacuum oven at 40 C until constant weight.

1. A degradable chewing gum base comprising at least one polymer or oligomer wherein the polymer or oligomer comprises at least two ionic groups.

2. A degradable chewing gum base according to claim 1, wherein the ionic groups are located anywhere on the polymer or oligomer molecule.

3. A degradable chewing gum base according to claim 1, wherein the ionic groups are located at the ends of the polymer or oligomer molecule.

4. A degradable chewing gum base according to claim 1, wherein the ionic groups are exclusively anionic, cationic or zwitterionic groups.

5. A degradable chewing gum base according to claim 1, wherein the ionic groups are a mixture of anionic, cationic or zwitterionic groups.

6. A degradable chewing gum base according to claim 1, wherein the ionic groups coordinate or bind to a second material.

7. A degradable chewing gum base according to claim 6, wherein the second material is a charged organic material, a non-charged organic material, a charged inorganic material, or a non-charged inorganic material.

8. A degradable chewing gum base according to claim 6, wherein the second material is a water-soluble magnesium salt or a water-soluble calcium salt.

9. A degradable chewing gum base according to claim 6, wherein the second material is a charged or non-charged polymer or oligomer with a different chemical structure than that of a degradable chewing gum base comprising at least one polymer or oligomer wherein the polymer or oligomer comprises at least two ionic groups.

10. A degradable chewing gum base according to claim 6, wherein the second material is a synthetic water-soluble polymer, a natural water-soluble polymer, a synthetic water-soluble oligomer, a natural water-soluble oligomer, a peptide, a disaccharide, an oligosaccharide, or a polysaccharide.

11. A degradable chewing gum base according to claim 6, wherein the second material is zein or soy protein.

12. A degradable chewing gum base according to claim 1, wherein the polymer or oligomer is made through ring opening, condensation, anionic, cationic, radical or atomic transfer radical polymerization.

13. A degradable chewing gum base according to claim 1, wherein the polymer or oligomer comprises a chemical functional group in the backbone of the polymer or oligomer chain, wherein the chemical functional group is an ester, a carbonate, an anhydride, or a urethane.

14. A degradable chewing gum base according to claim 13, wherein the polymer or oligomer is made from a monomer comprising glycolide, lactide, ethylene carbonate, trimethylene carbonate, β-butyrolactone, δ-valerolactone, ε-caprolactone, dioxanone or dioxepanone or any combinations thereof.

15. A degradable chewing gum base according to claim 14, further comprising a cyclic ester or carbonate skeleton, wherein the monomers of the cyclic ester or carbonate skeletons have one or more substituents of any carbon not being a carbonyl.

16. A degradable chewing gum base according to claim 1, wherein the polymer or oligomer comprises a monomer base comprising trimethylene carbonate-diol.

17. A degradable chewing gum base according to claim 1, wherein the polymer or oligomer comprises a copolymer comprising poly(trimethylene carbonate-co-p-dioxanone)-diol.

18. A degradable chewing gum base according to claim 17, wherein the copolymer has a ratio of trimethylene carbonate to p-dioxanone between 60:40 to 90:10.

19. A degradable chewing gum base according to claim 1, wherein the polymer or oligomer comprises a copolymer comprising poly(trimethylene carbonate-co-DL-lactide)-diol.

20. A degradable chewing gum base according to claim 1, wherein the polymer or oligomer comprises a copolymer comprising poly(trimethylene carbonate-co-ε-caprolactone-co-glycolide)-diol.

21. A degradable chewing gum base according to claim 1, wherein the polymer or oligomer break down to non-toxic molecules readily assimilated by nature when exposed to environmental conditions.

22. A degradable chewing gum base according to claim 1, further comprising a softening point less than about 37° C.

23. A degradable chewing gum base according to claim 1, further comprising an elastic shear modulus at a temperature about 30° C. of about 1 kPa to 50 MPa.

24. A chewing gum comprising conventional chewing gum components and a gum base according to claim 1.

25. A chewing gum according to claim 24, further comprising pharmaceutical additives, cosmetic additives, or mixtures thereof.

26. A method of making a degradable chewing gum base comprising adding at least one polymer or oligomer wherein the polymer or oligomer comprises at least two ionic groups.

27. The method of claim 26 comprising preparing the polymer or oligomer by ring opening, condensation, anionic, cationic, radical or atomic transfer radical polymerization.
